(19) United States
(12) Patent Application Publication
(10) Pub. No.: US 2007/0012409 A1
(43) Pub. Date: Jan. 18, 2007

(54) Rolling shutters

(76) Inventor: Yehezkel Twina, Ramat Gan (IL)

Correspondence Address: NATH & ASSOCIATES, 112 South West Street, Alexandria, VA, 22314, US

(21) Appl. No.: 11/178,499

(22) Filed: Jul. 12, 2005

(51) Int. Cl. E06B 3/12

(52) U.S. Cl. 160/235

(57) ABSTRACT

A shutter slat comprises lower and upper edges, and a first and a second sidewall defining together with the edges a hollow. The upper edge of the shutter slat has a hooked portion and is free of any openings to the hollow. The shutter slat is adapted for use in a shutter assembly, which comprises two such slats and a link comprising two hooked ends and a web therebetween. Each end of the link has a termination point and the points of the two ends are at different distances from the web.

### FIELD OF THE INVENTION

This invention relates to rolling shutters.

### BACKGROUND OF THE INVENTION

A rolling shutter is a multi-function shutter. Rolling shutters are utilized in windows, doors, and other openings in residential homes and other buildings.

Rolling shutters typically comprise slats positioned on atop another. In an open position, the slats are raised and are rolled around an upper shaft which is typically disposed within an enclosure, which may be internal or external to the building.

Rolling shutters have several advantages over standard shutters. One advantage is that when the shutter is in a fully open position, the entire area of the opening is exposed. In addition, assembly is simple, and it may be controlled by an electric motor.

A major disadvantage in existing rolling shutters is that when the shutter is in a closed position, only a small amount of light and air can enter. In order to let in more light and air, the entire shutter must be raised. It is common to raise the shutter partway in order to allow some light and air in. It is because of this disadvantage that many people do not use a rolling shutter. Nonetheless, rolling shutters are very popular in certain areas of the world, and their use is expanding. It would therefore be useful to provide a rolling shutter which allows a larger quantity of air and light to pass when it is in the closed position.

There have been several rolling shutters which have been manufactured to allow air and light to pass through via the slats. In a typical arrangement, the slats are hooked directly one to the next. The top of each slat typically comprises a hooked portion, which is grasped by toothed portion on the bottom of the next slat.

### SUMMARY OF THE INVENTION

According to the present invention, there is provided a shutter slat. The slat comprises lower and upper edges and a first and a second sidewall defining together with said edges a hollow. The upper edge has a hooked portion and is free of any openings to the hollow.

The shutter slat may additionally comprise, at the lower edge thereof, protrusions of different lengths. The lower edge may also comprise at least two apertures, each aperture adapted to receive a link.

The shutter slat may additionally comprise a gripping portion within the hollow adapted to receive therein a screw, and an end cap.

According to one embodiment, the first sidewall is convex and the second sidewall is concave. The hooked portion is open toward the first sidewall.

According to another embodiment, each of the sidewalls comprises an upper and a lower curved portion.

According to another aspect of the present invention, there is provided a link adapted to connect two slats of a rolling shutter assembly. The link has two hooked ends and a web therebetween. Each hooked end has a termination point, each of which is a different distances from the web.

According to a further aspect of the present invention, there is provided a shutter comprising at least two shutter slats as described above, and at least two links as described above. Each set of two adjacent slats are connected by at least two links.

In the shutter of the present invention, each slat comprises an upper projection along its length. The projection is adapted for catching therein links which are attached to the bottom portion of the slat immediately above. The projection is constructed to prevent any liquid from penetrating the upper surface of the slat and allows attaching to the slat above it.

Additionally, the shutter of the present invention comprises a slat having a double convex structure on the front thereof, and a double concave structure on the back thereof. This structure imparts an increased strength to the slat.

The shutter of the present invention comprises slats which are sealed at the upper ends, which does not allow penetration thereby of any fluids. It also comprises links which serve as to connect the slats and allow a large amount of air and light through the shutter.

### BRIEF DESCRIPTION OF THE DRAWINGS

In order to understand the invention and to see how it may be carried out in practice, an embodiment will now be described, by way of non-limiting example only, with reference to the accompanying drawings, in which:

FIG. 1 is a side view of a slat according to the present invention;

FIG. 2 is a perspective view of a link according to the present invention;

FIG. 3A is an exploded perspective view of the slat, showing placement of an end cap and the links;

FIG. 3B is a perspective view of the slat, with the end caps and links attached;

FIG. 4A though 4B show placement of a link in the slat;

FIGS. 5A and 5B are perspective and side views, respectively, of a shutter according to the present invention in a closed position;

FIGS. 6A is a perspective side view of the shutter in an open position with the end caps removed; and

6B is a side view of the shutter in an open position.

### DETAILED DESCRIPTION OF THE INVENTION

A shutter of the present invention comprises slat 1 and link 2.

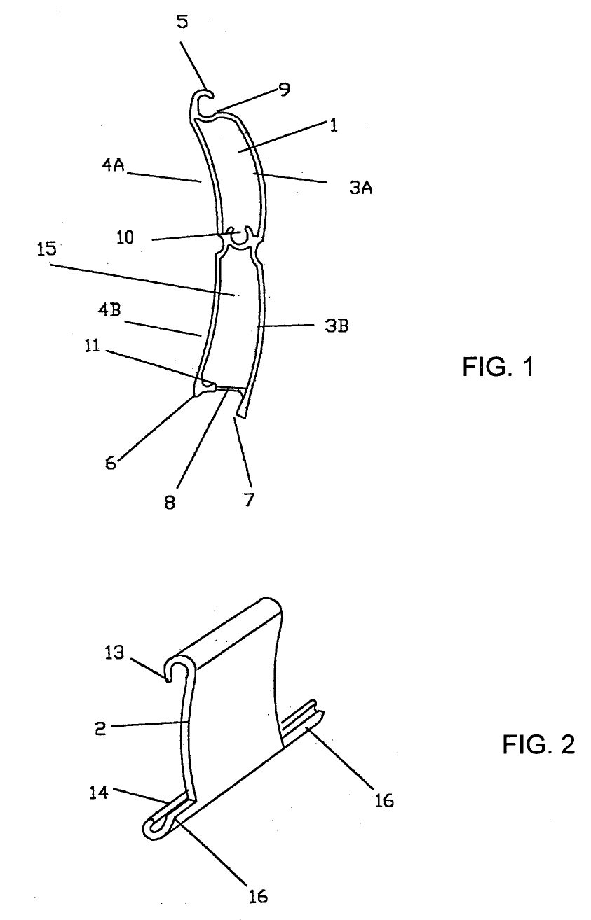

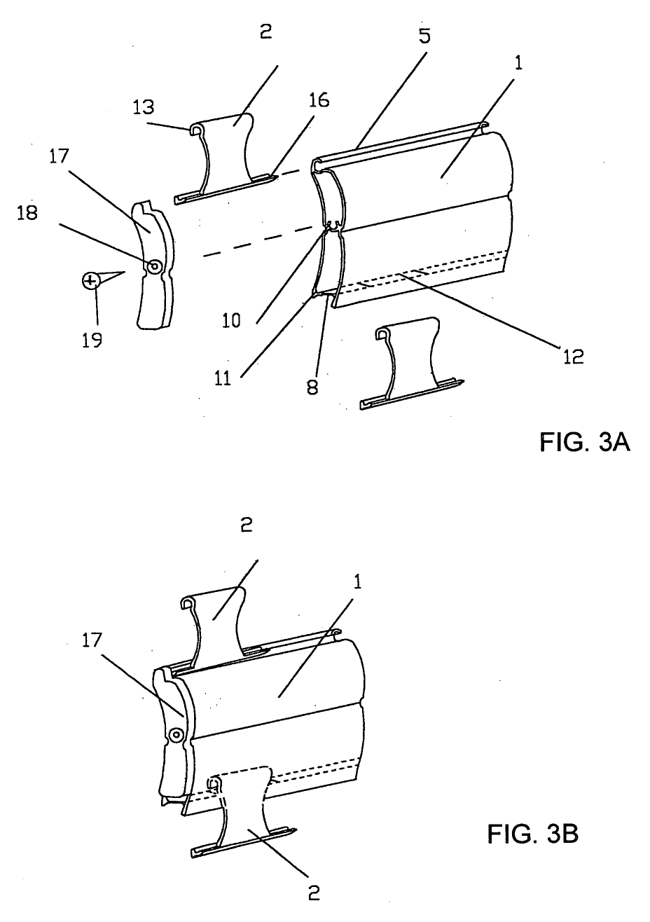

As seen in FIG. 1, the slat 1 comprises a front side having two concave sections 4A and 4B and a back side having two convex sections 3A and 3B. A bottom section has raising lip 11 and two sloped portions 6 and 7 in the front and back of the slat, respectively. The sloped portions 6 and 7 are useful for centering one slat atop the next. Disposed between the sloped portions 6 and 7 is a bottom wall 8. The bottom wall 8 comprises slots 12 which are adapted to receive the links 2 during assembly of the shutter. The top portion comprises a hooked portion 5, which is disposed above a stopper 9. Disposed within the slat 1 is a C-shaped profile 10 for receiving therein a screw 19 adapted to attach a cover 17 (seen in FIG. 3A) to the end of the slat 1. The center of the slat 1 comprises a hollow 15 for receipt therein of the link 2 when the shutter is in a closed position.

As seen in FIG. 2, the link 2 comprises an upper hook 13 and a lower hook 14. The lower hook 14 extends, forming a wing 16 on either side of the link 2.

The lower hook 14 is curved so that the end of the hook points back toward the lower part of the link 2. In this way, it may be clasped within the hooked portion 5 of the slat 1 and rotate freely without disengaging therefrom.

It should be noted that the wings 16 are an optional feature. The link 2 may be constructed without them.

As seen in FIGS. 3A and 3B, on either side of the slat is a plastic cover 17 which prevents the links 2 from disengaging from the slat 1. In the middle of the cover 17 is a hole 18 adapted to allow passage therethrough of the screw 19. The cover 17 is thus secured to the slat 1.

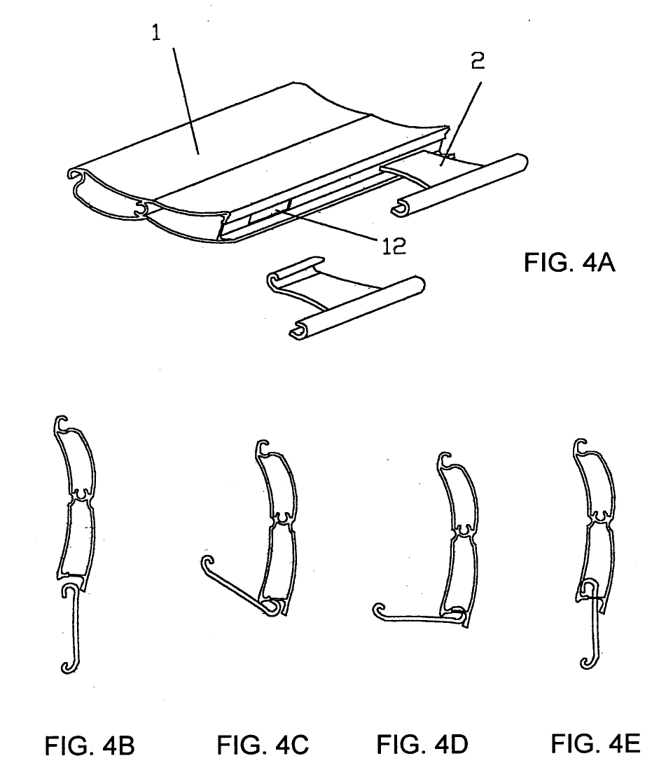

FIGS. 4A through 4E show how the link 2 is inserted into the slat 1. In order for the link 2 to fit in the slot 12, it must be positioned at a certain orientation thereto so that the upper hook 13 enters the slot at a required angle. After entering, the link is free to rotate within the hollow 15 of the slot without falling out therefrom.

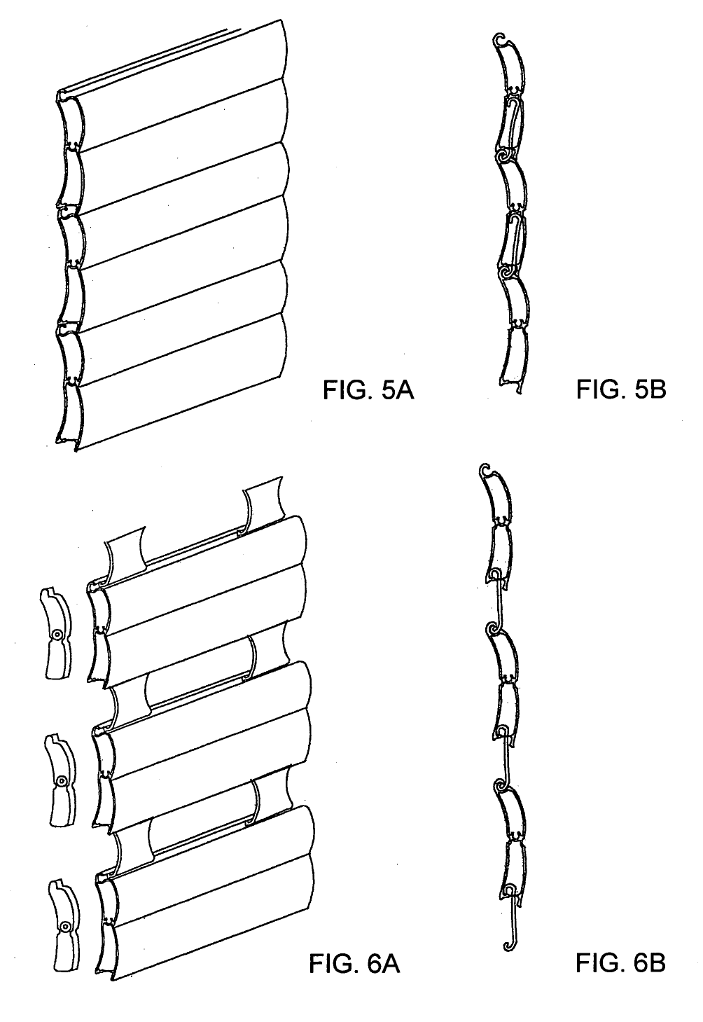

As illustrated in FIGS. 5A and 5B, the closed position of the shutter is when the shutter is down. In this position, each slat sits upon the one immediately below it. The slope portions 6 and 7 on the lower portion of the upper slat rest on the lower slat and position the upper slat thereon.

In the closed position, the link 2 is disposed largely within the recess 11 of the slat 1.

As illustrated in FIGS. 6A and 6B, when the shutter is partially raised, the topmost slat is raised until the raising lip 11 contacts the tongue 13 of the link 2 and the link is raised with the slat. Upon further raising of the shutter, the link 2 raises the slat 1 immediately below it with the engagement of the lower hook 14 in the hooked portion of the slat. This process continues with each subsequent slat.

As can be seen from FIG. 6A, when the shutter is partially raised, light and air may pass through it without having to fully raise the shutter. It could further be appreciated that when the shutter is to be wound about a shaft, it is wrapped so that the hooked portion 5 of the top of each slat 1 is disposed away from the shaft.

When the shutter is lowered, the shutter descends until the lowest slat reaches the ground or window sill. The slat immediately above comes to rest on it, with the link 2 entering the hollow. Once the slat is completely sitting on the one below it, the process begins with the next slat.

Those skilled in the art to which this invention pertains will readily appreciate that numerous changes, variations and modifications can be made without departing from the scope of the invention mutatis mutandis.

1. A shutter slat comprising:
(a) lower and upper edges; and
(b) a first and a second sidewall defining together with said edges a hollow;
said upper edge having a hooked portion and being free of any openings to the hollow.

2. A shutter slat according to claim 1, the lower edge further comprising protrusions, the protrusions being of different lengths.

3. A shutter slat according to claim 1, wherein the lower edge comprises at least two apertures each adapted to receive a link.

4. A shutter slat according to claim 1 further comprising a gripping portion within the hollow adapted to receive therein a screw.

5. A shutter slat according to claim 1, further comprising an end cap.

6. A shutter slat according to claim 1, wherein the first sidewall is convex and the second sidewall is concave, the hooked portion being open toward the first sidewall.

7. A shutter slat according to claim 1, wherein each of the sidewalls comprises upper and lower curved portions.

8. A link adapted to connect two slats of a rolling shutter assembly, the link comprising two hooked ends and a web therebetween, each hooked end having a termination point, the termination points being different distances from the web.

9. A shutter comprising:
(a) at least two shutter slats each comprising lower and upper edges; and a
first and a second sidewall defining together with said edges a hollow; said upper edge having a hooked portion and being free of any openings to the hollow; and
(b) at least two links each comprising two hooked ends and a web therebetween, each hooked end having a termination point, the termination points being different distances from the web.
wherein each set of two adjacent slats are connected by at least two links.
